(19) United States
(12) Patent Application Publication
(10) Pub. No.: US 2009/0026644 A1
(43) Pub. Date: Jan. 29, 2009

(54) Control Device for Molding Machine, Control Method for Molding Machine, and Molding Machine

(75) Inventors: Moto Masuda, Chiba (JP); Hideomi Hirano, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd.

(21) Appl. No.: 11/988,432

(22) PCT Filed: Jul. 14, 2006
(86) PCT No.: PCT/JP2006/314054

§ 371 Date: Jan. 8, 2008

(30) Foreign Application Priority Data
Jul. 15, 2005 (JP) 2005-207329
Jul. 20, 2005 (JP) 2005-209668

(51) Int. Cl. B29C 45/76

(52) U.S. Cl. 264/40.1; 425/149

(57) ABSTRACT

There are provided a control apparatus for a molding machine, a control method for a molding machine, and a molding machine, which can enhance the operability of an injection molding machine at all times, and can improve the productivity of molded products. The control apparatus includes state-determination processing means which determines a state of the molding machine; mode-setting processing means which sets, on the basis of the determined state of the molding machine, an operation mode in which the molding machine is operated; and molding-machine-operation processing means which operates the molding machine in the set operation mode. In this case, the operation mode in which the molding machine is operated is set on the basis of the determined state of the molding machine; and the molding machine is operated in the set mode. Accordingly, the productivity of molded products can be improved.

### TECHNICAL FIELD

The present invention relates to a control apparatus for a molding machine, a control method for a molding machine, and a molding machine.

### BACKGROUND ART

Conventionally, in a molding machine; for example, in an injection molding machine, resin heated and melted in a heating cylinder is injected under high pressure and charged into a cavity of a mold apparatus, and the injected resin is cooled and solidified in the cavity. Subsequently, a molded product; for example, a disk substrate, is removed from the mold apparatus.

The injection molding machine includes the mold apparatus, a mold-clamping apparatus, an injection apparatus, etc. The mold apparatus includes a stationary mold and a movable mold. The mold-clamping apparatus includes a stationary platen and a movable platen. The movable platen is advanced and retreated through drive of a mold-clamping motor to thereby perform mold closing, mold clamping, or mold opening.

Meanwhile, the injection apparatus includes a heating cylinder for heating and melting resin fed from a hopper, and an injection nozzle for injecting the molten resin. A screw is disposed in the heating cylinder such that the screw can rotate, advance, and retreat. In a metering step, when the screw is rotated through drive of a metering motor, resin is metered, and is accumulated forward of the screw within the heating cylinder. In an injection step, when the screw is advanced through drive of an injection motor, the resin accumulated forward of the screw is injected, and charged into a cavity of the mold apparatus in a clamped state.

When mold opening is performed after the resin within the cavity is cooled to complete a disk substrate, an ejection motor of an ejector apparatus is driven. As a result, an ejector pin is advanced so that the disk substrate is ejected and released from the mold. The disk substrate released from the mold can be taken out by means of a take-out machine, which grasps the disk substrate (see, for example, Patent Document 1).

When disk substrates are to be continuously molded through automatic operation, metering setting; i.e., setting molding conditions for metering the resin in the metering step, is performed (see, for example, Patent Document 2).

Patent Document 1: Japanese Patent Application Laid-Open (kokai) No. H10-113958.
Patent Document 2: Japanese Patent Application Laid-Open (kokai) No. H6-155534.

### DISCLOSURE OF THE INVENTION

### Problems to be Solved by the Invention

The conventional take-out machine easily takes a disk-substrate out of the mold apparatus within a short time when the state of the resin, the temperature of the mold apparatus, etc. are stable. However, when the state of the resin, the temperature of the mold apparatus, etc. are instable; e.g., when the injection molding machine is started up, a disk substrate is likely to adhere to the mold apparatus, and take-out of the disk substrate becomes difficult and takes a long time.

In view of the above, setting of the take-out machine is performed while a state at the time of start-up of the injection molding machine is used as a reference. However, in such a case, molding cycle becomes longer accordingly, and the productivity of disk substrates lowers.

Further, in the conventional injection molding machine, when disk substrates are molded, for example, through semi-automatic operation, take-out of a disk substrate from the mold apparatus becomes difficult in some cases, for example, when the injection molding machine is started up. In such a case the operability of the injection molding machine lowers, and the productivity of disk substrates lowers.

An object of the present invention is to solve the above-mentioned problems in the conventional take-out machine and injection molding machine, and to provide a control apparatus for a molding machine, a control method for a molding machine, and a molding machine, which can enhance the operability of an injection molding machine at all times, and can improve the productivity of molded products.

### Means for Solving the Problems

In order to achieve the above object, a control apparatus for a molding machine according to the present invention comprises state-determination processing means which determines a state of the molding machine; mode-setting processing means which sets, on the basis of the determined state of the molding machine, an operation mode in which the molding machine is operated; and molding-machine-operation processing means which operates the molding machine in the set operation mode.

Another control apparatus for a molding machine according to the present invention comprises state-determination processing means which determines a state of the molding machine; mode-setting processing means which selects and sets, on the basis of the determined state of the molding machine, one of a normal mode for taking out a molded product by operating a take-out machine with a normal setting and a designated mode for taking out the molded product by operating the take-out machine with a setting different from the normal setting; and take-out processing means which takes out the molded product in the set mode.

Still another control apparatus for a molding machine according to the present invention comprises mode-change-condition-determination processing means which determines, on the basis of a state of the molding machine, whether or not a mode changing condition for changing a mode of setting of molding conditions is satisfied; mode-setting processing means which determines and sets a selected mode when the mode changing condition is satisfied; molding-condition-setting processing means which sets molding conditions in the set mode; and molding processing means which performs molding under the set molding conditions.

### EFFECT OF THE INVENTION

According to the present invention, a control apparatus for a molding machine comprises state-determination processing means which determines a state of the molding machine; mode-setting processing means which sets, on the basis of the determined state of the molding machine, an operation mode in which the molding machine is operated; and molding-machine-operation processing means which operates the molding machine in the set operation mode.

In this case, the operation mode in which the molding machine is operated is set on the basis of the determined state of the molding machine; and the molding machine is operated in the set mode. Accordingly, the productivity of molded products can be improved.

Another control apparatus for a molding machine according to the present invention comprises state-determination processing means which determines a state of the molding machine; mode-setting processing means which selects and sets, on the basis of the determined state of the molding machine, one of a normal mode for taking out a molded product by operating a take-out machine with a normal setting and a designated mode for taking out the molded product by operating the take-out machine with a setting different from the normal setting; and take-out processing means which takes out the molded product in the set mode.

In this case, on the basis of the determined state of the molding machine, one of a normal mode for taking out a molded product by operating a take-out machine with a normal setting and a designated mode for taking out the molded product by operating the take-out machine with a setting different from the normal setting is selected and set. Therefore, molding cycles after completion of molding in the designated mode can be shortened. Accordingly, the productivity of the take-out machine can be improved.

Still another control apparatus for a molding machine according to the present invention comprises mode-change-condition-determination processing means which determines, on the basis of a state of the molding machine, whether or not a mode changing condition for changing a mode of setting of molding conditions is satisfied; mode-setting processing means which determines and sets a selected mode when the mode changing condition is satisfied; molding-condition-setting processing means which sets molding conditions in the set mode; and molding processing means which performs molding under the set molding conditions.

In this case, on the basis of a state of the molding machine, a determination is made as to whether or not a mode changing condition for changing the mode of setting of molding conditions is satisfied. Therefore, stable molding can be performed irrespective of the state of the molding machine.

Further, take-out of molded products from a mold apparatus becomes easier, the operability of the molding machine can be enhanced, and the productivity of molded products can be improved.

### BRIEF DESCRIPTION OF DRAWINGS

FIG. 1 is a block diagram of a control circuit of a take-out machine according to a first embodiment of the present invention.

FIG. 2 is a perspective view showing a main portion of an injection molding machine according to the first embodiment of the present invention.

FIG. 3 is a set of views showing the steps of taking out a disk substrate in the first embodiment of the present invention.

FIG. 4 is a representation showing a portion of a take-out setting input screen in the first embodiment of the present invention.

FIG. 5 is a perspective view showing a main portion of an injection molding machine according to a second embodiment of the present invention.

FIG. 6 is a schematic view of an injection molding machine according to a third embodiment of the present invention.

FIG. 7 is a block diagram showing a control circuit of the injection molding machine according to the third embodiment of the present invention.

FIG. 8 is a representation showing an example of a first molding-condition input screen in a normal mode in the third embodiment of the present invention.

FIG. 9 is a representation showing an example of a second molding-condition input screen in a designated mode in the third embodiment of the present invention.

### DESCRIPTION OF SYMBOLS

18: position detection section
25: take-out mechanism
29: take-out machine control section
34, 83: chuck plate
44, 117: display section
114: control section
116: operation section
151: injection apparatus
152: mold apparatus
153: mold-clamping apparatus
AR33: area
d1: disk substrate

### BEST MODE FOR CARRYING OUT THE INVENTION

The embodiments of the present invention will next be described in detail with reference to the drawings. Notably, in the following description, an injection molding machine, which is an example molding machine, will be described. Further, a control apparatus of an injection molding machine; i.e., an injection molding machine control apparatus, and a control apparatus of a take-out machine; i.e., a take-out machine control apparatus, will be described as a control apparatus for a molding machine.

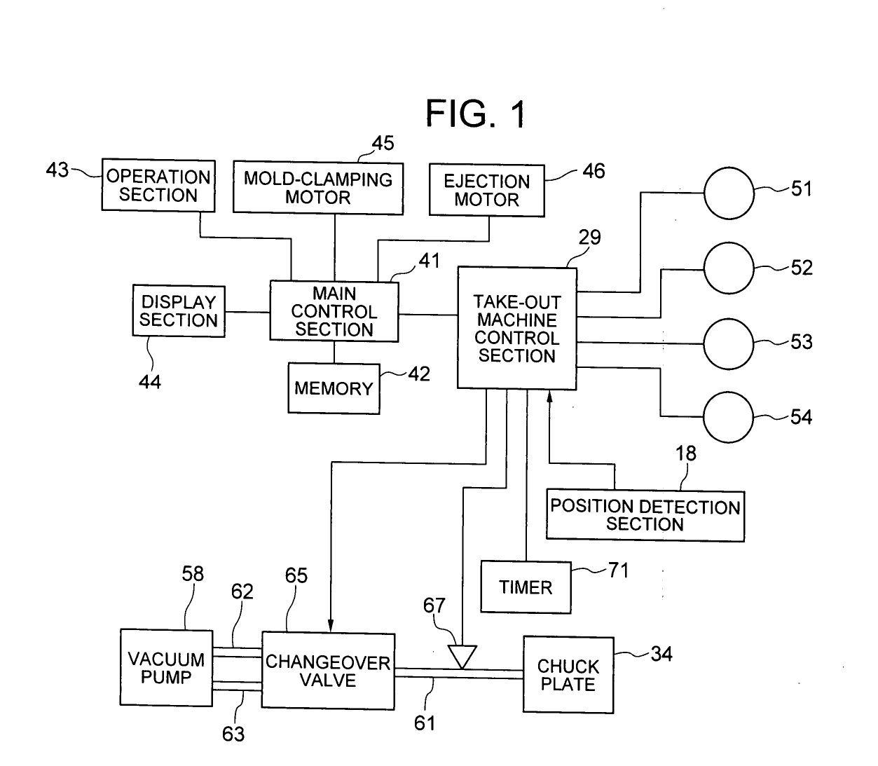

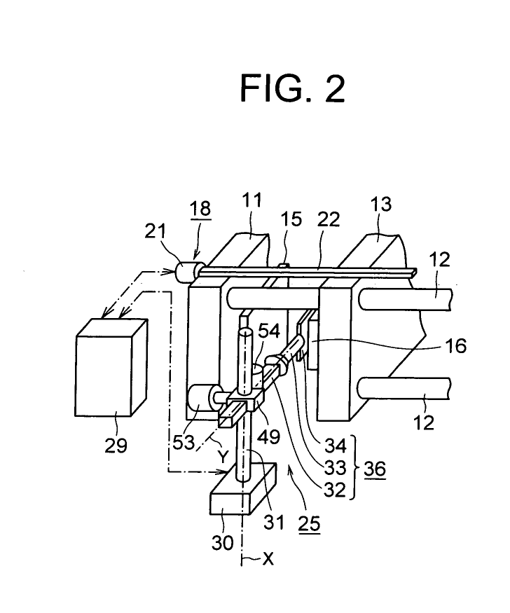

FIG. 1 is a block diagram of a control circuit of a take-out machine according to a first embodiment of the present invention. FIG. 2 is a perspective view showing a main portion of an injection molding machine according to the first embodiment of the present invention.

In these drawings, reference numeral 11 denotes a stationary platen (first platen). The stationary platen 11 and an unillustrated toggle support (base plate) are disposed to face each other, and four tie bars 12 (only two of the four tie bars 12 are shown in FIG. 2) are disposed to extend between the stationary platen 11 and the toggle support. Further, a movable platen (second platen) 13 is disposed to face the stationary platen 11 such that the movable platen 13 can advance and retreat along the tie bars 12. An unillustrated toggle mechanism is disposed between the toggle support and the movable platen 13. When a mold-clamping motor (drive section for mold clamping) 45 is driven, a generated rotation is transmitted to the toggle mechanism, so that the movable platen 13 is advanced or retreated. Notably, the stationary platen 11, the toggle support, the movable platen 13, the toggle mechanism, the mold-clamping motor 45, etc. constitute a mold-clamping apparatus.

A stationary mold 15 and a movable mold 16 are attached to the stationary platen 11 and the movable platen 13, respectively, such that the stationary mold 15 and the movable mold 16 face each other. The stationary mold 15 and the movable mold 16 constitute a mold apparatus.

Reference numeral 41 denotes a main control section (first control section). The main control section 41 is composed of a CPU (processing apparatus), and functions as a computer on the basis of various data to thereby perform various types of processing. Notably, in place of the CPU, an MPU may be used as the processing apparatus. Reference numeral 42 denotes memory such as RAM, ROM, flash memory, or the like. Reference numeral 43 denotes an operation section equipped with operating elements such as switches, keys, and buttons. Reference numeral 44 denotes a display section equipped with a display, lamps, etc. The operation section 43 and the display section 44 are disposed on an unillustrated operation panel. Notably, a touch panel in which the operation section 43 and the display section 44 are integrated together may be used.

In the mold-clamping apparatus having the above-described structure, when unillustrated mold-opening/closing processing means (a mold-opening/closing processing section) of the main control section 41 performs mold-opening/closing processing to thereby drive the mold-clamping motor 45, the toggle mechanism is extended. As a result, the movable platen 13 is advanced so as to perform mold closing, whereby the movable mold 16 is brought into contact with the stationary mold 15. Subsequently, when the mold-clamping motor 45 is further driven, the toggle mechanism generates a mold-clamping force, with which the movable mold 16 is pressed against the stationary mold 15, to thereby perform mold clamping. As a result, a cavity is formed between the stationary mold 15 and the movable mold 16. When the mold-clamping motor 45 is driven in the reverse direction, the toggle mechanism is contracted, whereby the movable platen 13 is retreated, and thus, mold opening is performed.

Then, in the mold clamped state, resin (molding material) is injected from an unillustrated injection apparatus, and is charged into the cavity. When the resin is cooled, a disk substrate (molded product) is produced.

When mold opening is subsequently performed, an ejection motor (drive section for ejection) 46 is driven in an unillustrated ejector apparatus disposed on the movable platen 13 so as to advance an ejector pin, so that the disk substrate is ejected and released from the mold. At that time, a take-out machine is operated to grasp and take out the disk substrate.

The take-out machine includes a take-out machine control section (second control section) 29 connected to the main control section 41; a position detection section 18 which detects the position of the movable platen 13; i.e., the movable mold 16; and a take-out mechanism 25 for taking out a disk substrate. The position detection section 18 includes an encoder 21 attached to the stationary platen 11 and a magnetic scale 22 attached to the movable platen 13 and extending between the stationary platen 11 and the movable platen 13. When the movable platen 13 moves, the magnetic scale 22 is moved in relation to the encoder 21, whereby the encoder 21 continuously detects the position of the movable mold 16 and sends the detected position to the take-out machine control section 29. The take-out machine control section 29 is composed of a CPU (processing apparatus), and functions as a computer on the basis of various data to thereby perform various types of processing. Notably, in place of the CPU, an MPU may be used as the processing apparatus.

The take-out mechanism 25 includes a base 30 disposed to be movable in a first direction parallel to the tie bars 12; a bar-shaped support member 31 projecting upward from the base 30; a holding member 49 disposed to be movable along the support member 31 in a vertical (X-axis) direction (second direction) perpendicular to the first direction; an arm member 32 extending from the holding member 49 in a horizontal (Y-axis) direction (third direction) perpendicular to the first and second directions; a take-out arm 33 attached to the arm member 32; and a chuck plate (grasping member) 34 attached to a distal end of the take-out arm 33. The arm member 32, the take-out arm 33, and the chuck plate 34 constitute a mold entry/retreat section 36.

A servomotor (first drive section) 51 is provided so as to move the base 30. Further, an unillustrated pneumatic device and a servomotor (second drive section) 52 are disposed within the base 30; a servomotor (third drive section) 53 is disposed on the holding member 49; and a servomotor (fourth drive section) 54 is disposed on the arm member 32.

Unillustrated take-out-machine-operation processing means (a take-out-machine-operation processing section) of the take-out machine control section 29 performs take-out-machine-operation processing. That is, the take-out-machine-operation processing means can move the chuck plate 34 in a direction parallel to the tie bars 12 through drive of the servomotor 51; rotate the chuck plate 34 in relation to the holding member 49 through drive of the servomotor 52; move the chuck plate 34 in a vertical direction through drive of the servomotor 53; and move the chuck plate 34 in a horizontal direction through drive of the servomotor 54. Notably, reference numeral 58 denotes a vacuum pump (negative pressure source); 61 to 63 denote pipe lines; 65 denotes a changeover valve; 67 denotes a pressure sensor (pressure detection section) disposed in the pipe line 61; and 71 denotes a timer. The take-out machine control section 29 constitutes a take-out machine control apparatus. In the present embodiment, the take-out machine control section 29 and the main control section 41 are formed separately from each other; however, they may be integrally formed.

Next, there will be described steps of taking out a disk substrate from the mold apparatus through use of the take-out machine having the above-described structure.

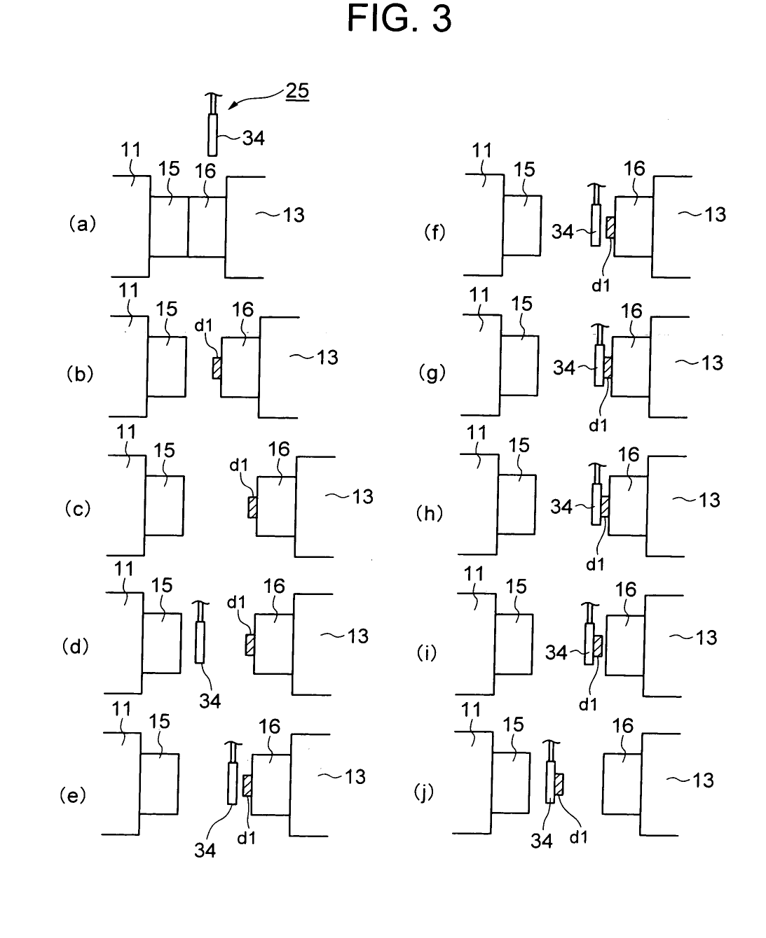

FIG. 3 is a set of views showing the steps of taking out a disk substrate in the first embodiment of the present invention.

In FIG. 3, reference numeral 11 denotes the stationary platen; 13 denotes the movable platen; 15 denotes the stationary mold; 16 denotes the movable mold; 25 denotes the take-out mechanism; 34 denotes the chuck plate; and d1 denotes a disk substrate.

First, as shown in FIG. 3(a), the movable mold 16 is pressed against the stationary mold 15, so that a cavity is formed between the stationary mold 15 and the movable mold 16. At that time, the chuck plate 34 stands by at a predetermined position; i.e., a retreat position, in the vicinity of the mold apparatus. When a mold open signal is fed from the main control section 41 (FIG. 1) to the mold-clamping motor 45 in this state, the mold-clamping motor 45 is driven so as to retreat the movable platen 13, whereby mold opening is started as shown in FIG. 3(b).

When the movable mold 16 has reached a mold open limit position as shown in FIG. 3(c), the above-described take-out-machine-operation processing means feeds a mold entry start signal to the servomotors 51 to 54. As a result, as shown in FIG. 3(d), the chuck plate 34 enters a space between the stationary mold 15 and the movable mold 16. Subsequently, as shown in FIG. 3(e), the chuck plate 34 is placed at a position facing the disk substrate d1; i.e., an operation position.

Subsequently, as shown in FIG. 3(f), unillustrated ejection processing means (a ejection processing section) of the main control section 41 performs ejection processing so as to send an ejection start signal to the ejection motor 46. As a result, the unillustrated ejector pin ejects the disk substrate d1.

Next, as shown in FIG. 3(g), the above-described take-out-machine-operation processing means drives the servomotor so as to advance the chuck plate 34 and bring the same in contact with the disk substrate d1, and feeds a negative pressure from the vacuum pump 58 to the chuck plate 34. As a result, the chuck plate 34 attracts and grasps the disk substrate d1. At that time, the take-out-machine-operation processing means causes the timer 71 to start clocking at timing t at which the chuck plate 34 comes into contact with the disk substrate d1.

Notably, the vacuum pump 58 and the chuck plate 34 are connected via the pipe lines 61 to 63 and the changeover valve 65. Through changeover of the changeover valve 65, a first negative pressure P1 or a second negative pressure P2 lower (higher in vacuum degree) than the first negative pressure P1 can be fed to the chuck plate 34. The negative pressure fed to the chuck plate 34 is detected by the pressure sensor 67.

When a withdrawal return waiting time T1 has elapsed in a state where the chuck plate 34 is in contact with the disk substrate d1 as shown in FIG. 3(h) and the clocking by the timer 71 ends, the take-out-machine-operation processing means drives the servomotor 51 in the reverse direction to thereby retreat the chuck plate 34 as shown in FIG. 3(i). After positioning the chuck plate 34 at a position shown in FIG. 3(j), the take-out-machine-operation processing means moves the chuck plate 34 to a retreat position outside the mold. When a time required to develop an attraction force sufficient to attract the disk substrate d1 by means of the negative pressure supplied to the chuck plate 34 in a state in which the chuck plate 34 is contact with the disk substrate d1 is represented by τ0, the withdrawal return waiting time τ1 is set to be longer than the time τ0 by a predetermined margin.

Incidentally, when the state of the resin, the temperature of the mold apparatus, etc. are stable, take-out of the disk substrate d1 from the mold apparatus is easy, and the disk substrate d1 can be removed in a short time. However, when the state of the resin, the temperature of the mold apparatus, etc. are instable; e.g., when the injection molding machine is started up, the disk substrate d1 is likely to adhere to the mold apparatus, and take-out of the disk substrate d1 becomes difficult. In such a case, the take-out of the disk substrate d1 takes a long time, whereby the molding cycle becomes longer accordingly.

In view of the above, in the present embodiment, the take-out machine control apparatus is configured to allow selection of one of a normal mode (first operation mode) for taking out the disk substrate d1 by operating the take-out machine with a normal setting and a designated mode (second operation mode) for taking out the disk substrate d1 by operating the take-out machine with a setting different from the normal setting. For such selection, unillustrated state-determination processing means (a state-determination processing section) of the take-out machine control section 29 performs state-determination processing so as to read a predetermined variable; e.g., a shot number N of the injection molding machine, and determines whether the injection molding machine is in a state immediate after startup or in a state where molding is stable, by determining whether or not the shot number N is equal to or less than a threshold value Nth. Unillustrated mode-setting processing means (a mode-setting processing section) of the take-out machine control section 29 performs mode-setting processing so as to select and set one of the normal mode and the designated mode on the basis of the state of the injection molding machine. In the present embodiment, when the shot number N is equal to or less than the threshold value Nth, the injection molding machine is determined to be in a state immediately after startup, and the designated mode is set; and when the shot number N is greater than the threshold value Nth, the injection molding machine is determined to be in a state where molding is stable, and the normal mode is set.

Accordingly, unillustrated take-out processing means (a take-out processing section), which serves as first molding-machine-operation processing means (a first molding-machine-operation processing section), of the take-out machine control section 29 performs take-out processing (first molding-machine-operation processing) so as to operate the take-out machine with different settings, depending on whether the set mode is the normal mode or the designated mode. That is, when the set mode is the designated mode, the take-out processing means takes out the disk substrate d1 through an operation different from that in the normal mode, for example, by retreating the chuck plate 34 after elapse of a sufficient time after bringing the chuck plate 34 into contact with the disk substrate d1.

For such operation, unillustrated display processing means (a display processing section) of the main control section 41 performs display processing so as to form, on the display section 44, a first take-out setting input screen for operating the take-out machine in the normal mode and a second take-out setting input screen for operating the take-out machine in the designated mode, so as to enable an operator to set the withdrawal return waiting time τ1 on the second take-out setting input screen to be longer than that in the normal mode.

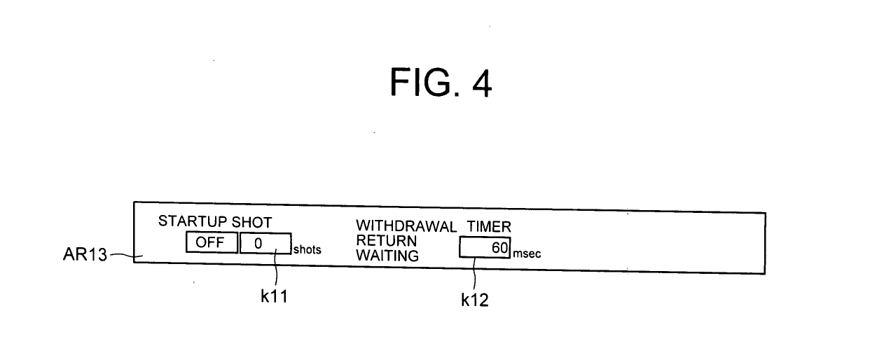

FIG. 4 is a representation showing a portion of a take-out setting input screen in the first embodiment of the present invention.

In FIG. 4, AR13 is an area for changing the setting of the take-out machine in accordance with the conditions of the injection molding machine and setting the designated mode. Windows k11 and k12 are formed in the area AR13. The window k11 is used to input the threshold value Nth of the shot number N for determining that the take-out machine must be operated in the designated mode. The window k12 is used to input the withdrawal return waiting time τ1 used in a period in which the take-out machine is operated in the designated mode. Accordingly, when an operator inputs the threshold value Nth and the withdrawal return waiting time τ1 by operating the operation section 43 (FIG. 1), unillustrated setting-change processing means (a setting-change processing section) of the take-out machine control section 29 performs setting-change processing to thereby set the take-out machine with the input threshold value Nth and withdrawal return waiting time τ1.

As described above, in the present embodiment, when the state of the resin, the temperature of the mold apparatus, etc. are instable; e.g., when the injection molding machine is started up, the take-out machine is operated in the designated mode until molding is performed by a predetermined number of shots, so that the disk substrate d1 is taken out after elapse of the withdrawal return waiting time τ1. After that, the take-out machine is operated in the normal mode. Therefore, molding cycles after completion of molding in the designated mode can be shortened. Accordingly, the productivity of the take-out machine can be improved.

In the present embodiment, the setting-change processing means sets the withdrawal return waiting time τ1 in the designated mode to be longer than that in the normal mode. However, in the designated mode, the setting-change processing means may set an attraction checking pressure for judging whether the negative pressure supplied to the chuck plate 34 is sufficient for attracting the disk substrate d1 such that the attraction checking pressure becomes lower (higher in the negative direction) than that in the normal mode; may change the negative pressure generated at the vacuum pump 58 to thereby set the negative pressure supplied to the chuck plate 34 to be lower (higher in the negative direction) than that in the normal mode; may switch the changeover valve 65 to thereby set the negative pressure supplied to the chuck plate 34 to be lower (higher in the negative direction) than that in the normal mode; may set a stroke over which the chuck plate 34 is advanced further after coming into contact with the disk substrate d1 such that the stroke becomes longer than that in the normal mode; or may set a pressing force with which the chuck plate 34 is pressed against the disk substrate d1 such that the pressing force becomes higher than that in the normal mode.

In the present embodiment, the state-determination processing means of the take-out machine control section 29 is configured to read the shot number N and determine the state of the injection molding machine by determining whether or not the shot number N is equal to or less than the threshold value Nth. However, the main control section 41 may determine the state of the injection molding machine. In this case, the state-determination processing means determines the state of the injection molding machine by determining whether or not the shot number N is equal to or less than the threshold value Nth, and outputs (I/O output) the determination results to the take-out machine control section 29 as a state signal. Accordingly, in the take-out machine control section 29, the above-described mode-setting processing means reads the state signal and sets the mode. Further, via communications, the determination results associated with the state of the injection molding machine can be sent from the main control section 41 to the take-out machine control section 29, as the state signal.

Further, when the molding cycle of the injection molding machine is lengthened in response to a need, the state of the resin, the temperature of the mold apparatus, etc. become instable, so that the disk substrate d1 becomes likely to adhere to the inner circumferential surface of the cavity, and take-out of the disk substrate d1 from the mold apparatus becomes difficult. In view of this, in a state where the molding cycle of the injection molding machine is lengthened, the mode-setting processing means can select the designated mode.

Further, when an error occurs in take-out of the disk substrate d1, the injection molding machine may be stopped for a short period of time. When the operation of the injection molding machine is resumed after that, the state of the resin, the temperature of the mold apparatus, etc. become instable, so that the disk substrate d1 becomes likely to adhere to the inner circumferential surface of the cavity, and take-out of the disk substrate d1 becomes difficult. In view of this, when the injection molding machine is stopped for a short period of time and its operation is resumed, the mode-setting processing means can select the designated mode.

In the present embodiment, the state-determination processing means is configured to determine the state of the injection molding machine through comparison between the shot number N and the threshold value Nth. However, an operator may visually determine the state of the injection molding machine and set the mode through operation of the operation section 43. In this case, a button is provided on the operation section 43 or a key is provided on the setting screen formed on the display section 44; and the state-determination processing means determines the state of the injection molding machine by determining whether or not the operator has pressed the button or has touched the key.

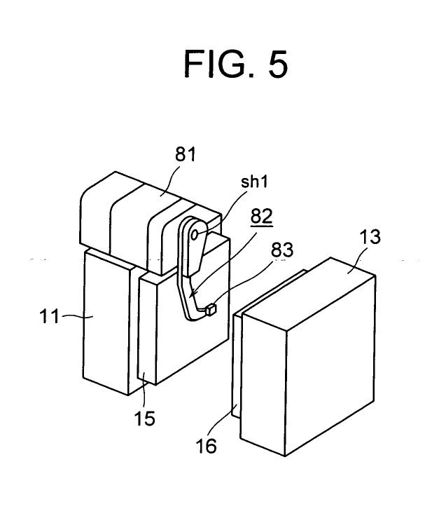

FIG. 5 is a perspective view showing a main portion of an injection molding machine according to a second embodiment of the present invention. Notably, components having the same structures as those in the first embodiment are denoted by the same reference numerals, and their repeated descriptions are omitted. For the effect that the second embodiment yields through employment of the same structure, the description of the effect of the first embodiment is incorporated herein by reference.

In FIG. 5, reference numeral 81 denotes a take-out machine; 82 denotes an arm member disposed pivotably about a turning shaft sh1; and 83 denotes a chuck plate (grasping member) attached to the distal end of the arm member 82.

In this case, the arm member 82 pivots through drive of an unillustrated servomotor serving as a taking out drive section. As a result, the chuck plate 83 assumes a retreat position in the vicinity of the mold apparatus and an operation position facing an unillustrated disk substrate.

Incidentally, in the injection molding machine having the above-described structure, when disk substrates are molded, for example, through semi-automatic operation, take-out of a disk substrate from the mold apparatus becomes difficult in some cases, for example, when the injection molding machine is started up. In such a case the operability of the injection molding machine lowers, and the productivity of disk substrates lowers.

In view of the above, there will be described a molding machine which can enhance the operability of the injection molding machine and improve the productivity of disk substrates.

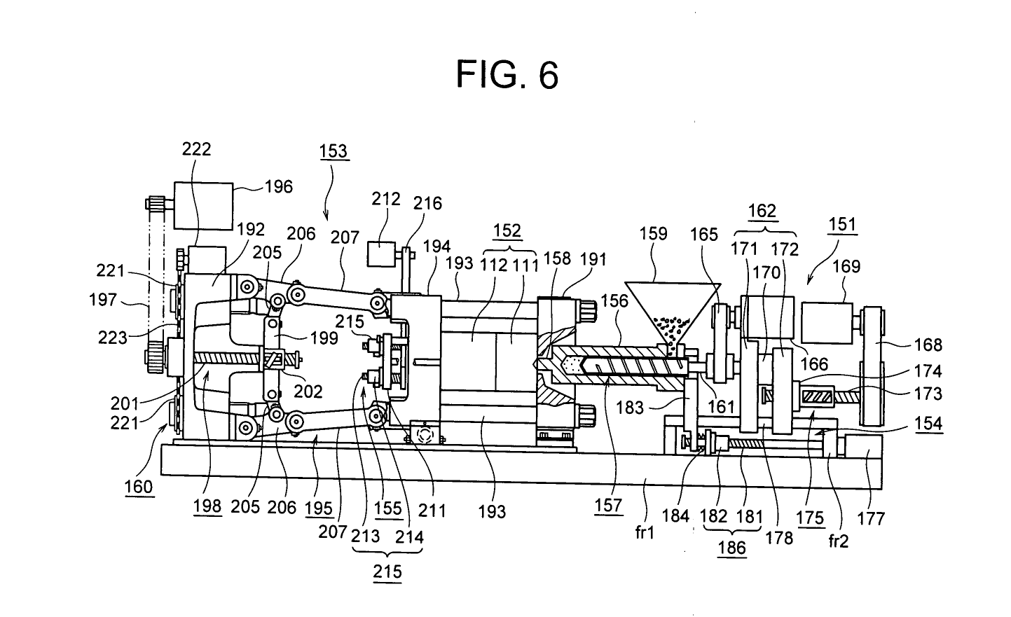

FIG. 6 is a schematic view of an injection molding machine according to a third embodiment of the present invention.

In FIG. 6, reference numeral 151 denotes an injection apparatus; 152 denotes a mold apparatus composed of a stationary mold (first mold) 111 and a movable mold (second mold) 112; 153 denotes a mold-clamping apparatus disposed in opposition to the injection apparatus 151; 154 denotes a plastifying-and-moving apparatus which supports the injection apparatus 151 such that the injection apparatus can advance and retreat; 155 denotes an ejector apparatus; 160 denotes a mold-thickness-adjusting apparatus, functioning as a toggle adjustment apparatus; and fr1 denotes a molding machine frame which supports the injection apparatus 151, the mold-clamping apparatus 153, the plastifying-and-moving apparatus 154, etc.

The injection apparatus 151 includes a heating cylinder (cylinder member) 156; a screw (injection member) 157 disposed in the heating cylinder 156 such that the screw 157 can rotate, advance, and retreat; an injection nozzle 158 attached to the front end of the heating cylinder 156; a hopper 159 provided on the heating cylinder 156 in the vicinity of the rear end thereof; a screw shaft 161 projecting from the rear end of the screw 157; a pressure plate 162 which includes front and rear support portions 171 and 172 connected together via a load cell (load detection section) 170, which is disposed such that the pressure plate 162 can advance and retreat, and which rotatably supports the screw shaft 161; a metering motor (drive section for metering) 166 attached to the front support portion 171 and connected to the screw shaft 161 via a pulley-and-belt-type rotation transmission system (composed of a drive pulley (drive element), a driven pulley (driven element), and a timing belt (transmission member) extending between and wound around the drive pulley and the driven pulley) 165; an injection motor (drive section for injection) 169 attached to the molding machine frame fr1 and connected to a ball screw (motion-direction conversion section) 175 via a pulley-and-belt-type rotation transmission system (composed of a drive pulley (drive element), a driven pulley (driven element), and a timing belt (transmission member) extending between and wound around the drive pulley and the driven pulley) 168; etc. The ball screw 175 functions as a motion-direction conversion section for converting rotation motion to rectilinear motion, and includes a ball screw shaft (first conversion element) 173 connected to the rotation transmission system 168, and a ball nut (second conversion element) 174 attached to the rear support portion 172 and meshing with the ball screw shaft 173.

The plastifying-and-moving apparatus 154 includes an injection apparatus frame fr2; a plasticizing-moving motor (drive section for plasticizing and moving) 177 attached to the injection apparatus frame fr2; a guide 178 disposed along the longitudinal direction of the injection apparatus frame fr2 so as to guide the front support portion 171 and the rear support portion 172; a ball screw shaft (first conversion element) 181 rotatably disposed on the injection apparatus frame fr2 and rotated through drive of the plasticizing-moving motor 177; a ball nut (second conversion element) 182 meshing with the ball screw shaft 181; a bracket 183 attached to the rear end of the heating cylinder 156; a spring (urging member) 184 disposed between the ball nut 182 and the bracket 183; etc. Notably, the ball screw shaft 181 and the ball nut 182 constitute a ball screw 186, which functions as a motion-direction conversion section for converting rotation motion to rectilinear motion.

The mold-clamping apparatus 153 includes a stationary platen (first platen) 191 attached to the molding machine frame fr1; a toggle support (base plate) 192; tie bars 193 (in the drawing, only two of the four tie bars 193 are shown) extending between the stationary platen 191 and the toggle support 192; a movable platen (second platen) 194 disposed in opposition to the stationary platen 191 such that the movable platen 194 can advance and retreat along the tie bars 193; a toggle mechanism 195 disposed between the movable platen 194 and the toggle support 192; a mold-clamping motor (drive section for mold clamping) 196; a pulley-and-belt-type rotation transmission system (composed of a drive pulley (drive element), a driven pulley (driven element), and a timing belt (transmission member) extending between and wound around the drive pulley and the driven pulley) 197 for transmitting to the toggle mechanism 195 rotation generated upon drive of the mold-clamping motor 196; a ball screw (motion-direction conversion section) 198 connected to the rotation transmission system 197; a crosshead 199 connected to the ball screw 198; etc. The stationary mold 111 and the movable mold 112 are attached to the stationary platen 191 and the movable platen 194, respectively, to face each other.

The ball screw 198 functions as a motion-direction conversion section for converting rotation motion to rectilinear motion, and includes a ball screw shat (first conversion element) 201 connected to the rotation transmission system 197, and a ball nut (second conversion element) 202 attached to the crosshead 199 and meshing with the ball screw shaft 201.

The toggle mechanism 195 includes toggle levers 205 pivotably supported on the crosshead 199; toggle levers 206 pivotably supported on the toggle support 192; and toggle arms 207 pivotably supported on the movable platen 194. The toggle levers 205 and the toggle levers 206 are mutually link-connected; and the toggle levers 206 and the toggle arms 207 are mutually link-connected.

The toggle mechanism 195 operates as follows. When the crosshead 199 is advanced or retreated between the toggle support 192 and the movable platen 194 by means of driving the mold-clamping motor 196, the movable platen 194 advances or retreats along the tie bars 193 so as to bring the movable mold 112 into contact with the stationary mold 111 or separate the movable mold 112 from the stationary mold 111, to thereby perform mold closing, mold clamping, or mold opening.

The ejector apparatus 155 includes a crosshead 211 disposed on the rear end surface of the movable platen 194 such that the crosshead 211 can advance and retreat in relation to the movable platen 194; an ejection motor (drive section for ejection) 212; a ball screw shaft (first conversion element) 213 disposed to be rotatable in relation to the crosshead 211; a ball nut (second conversion element) 214 attached to the crosshead 211 and meshing with the ball screw shaft 213; a pulley-and-belt-type rotation transmission system (composed of a drive pulley (drive element), a driven pulley (driven element), and a timing belt (transmission member) extending between and wound around the drive pulley and the driven pulley) 216 for transmitting to the ball screw shaft 213 rotation generated upon drive of the ejection motor 212; an ejector rod and ejector pins, both not shown, which are advanced and retreated with advancement and retreat of the crosshead 211; etc. Notably, the ball screw shaft 213 and the ball nut 214 constitute a ball screw 215, which functions as a motion-direction conversion section for converting rotation motion to rectilinear motion.

The mold-thickness-adjusting apparatus 160 includes adjustment nuts (each serving as a toggle adjustment member and a mold-thickness-adjusting member) 221 meshing with screw portions formed at the rear ends of the tie bars 193; a mold-thickness-adjusting motor (serving as a drive section for toggle adjustment and a drive section for mold-thickness adjustment) 222; a timing belt (transmission member) 223 for transmitting to the adjustment nuts 221 rotation generated upon drive of the mold-thickness adjusting motor 222; etc. The mold-thickness-adjusting apparatus 160 advances or retreats the toggle support 192 in relation to the stationary platen 191 to thereby perform mold-thickness adjustment.

The injection apparatus 151 having the above-described structure operates as follows. When the plasticizing-moving motor 177 is driven, the rotation generated by the plasticizing-moving motor 177 is transmitted to the ball screw shaft 181, whereby the ball nut 182 is advanced or retreated. The thrust force generated by the ball nut 182 is transmitted to the bracket 183 via the spring 184, whereby the injection apparatus 151 is advanced or retreated.

In a metering step, the metering motor 166 is driven. The rotation generated by the metering motor 166 is transmitted to the screw shaft 161 via the rotation transmission system 165, whereby the screw 157 is rotated. As a result, the resin (molding material), which is supplied from the hopper 159 and which is heated and melted within the heating cylinder 156, is caused to move forward, and is accumulated forward of the screw 157. With this, the screw 157 is retreated to a predetermined position.

In an injection step, the injection nozzle 158 is pressed against the stationary mold 111, and the injection motor 169 is driven so as to rotate the ball screw shaft 173 via the rotation transmission system 168. At this time, the pressure plate 162 moves, as the ball screw 173 rotates, and advances the screw 157. As a result, the resin accumulated forward of the screw 157 is injected from the injection nozzle 158, and charged into an unillustrated cavity formed between the stationary mold 111 and the movable mold 112. The load cell 170 receives the reaction generated at that time, and detects the pressure.

The mold-clamping apparatus 153 and the ejector apparatus 155 having the above-described structures operate as follows. When the mold-clamping motor 196 is driven, the rotation generated by the mold-clamping motor 196 is transmitted to the ball screw shaft 201 via the rotation transmission system 197, whereby the ball nut 202 is advanced or retreated together with the crosshead 199. When the crosshead 199 advances, the toggle mechanism 195 is extended, whereby the movable platen 194 is advanced to perform mold closing, and the movable mold 112 comes into contact with the stationary mold 111. Subsequently, when the mold-clamping motor 196 is further driven, the toggle mechanism 195 generates a mold-clamping force, with which the movable mold 112 is pressed against the stationary mold 111, whereby the above-mentioned cavity is formed between the stationary mold 111 and the movable mold 112. When the crosshead 199 retreats, the toggle mechanism 195 is contracted, whereby the movable platen 194 is retreated to perform mold opening.

Subsequently, when the ejection motor 212 is driven, rotation of the ejection motor 212 is transmitted to the ball screw shaft 213 via the rotation transmission system 216, whereby the crosshead 211 is advanced or retreated, and thus, the ejector rod is advanced or retreated. When the crosshead 211 is advanced through drive of the ejection motor 212 in the course of mold opening, the ejector pins are advanced, and a disk substrate is ejected.

Further, at that time, an unillustrated take-out machine is operated, whereby the disk substrate is grasped and taken out.

The mold-thickness-adjusting apparatus 160 having the above-described structure operates as follows. When the mold-thickness adjusting motor 222 is driven, the rotation generated by the mold-thickness adjusting motor 222 is transmitted to the adjustment nuts 221 via the timing belt 223. As a result of being rotated, the adjustment nuts 221 advance or retreat in relation to the tie bars 193 to thereby advance or retreat the toggle support 192. Consequently, the mold thickness is adjusted, and the reference position of the toggle mechanism 195 is adjusted.

Incidentally, an operator can set molding conditions in the injection molding machine by operating the above-described operation section 43.

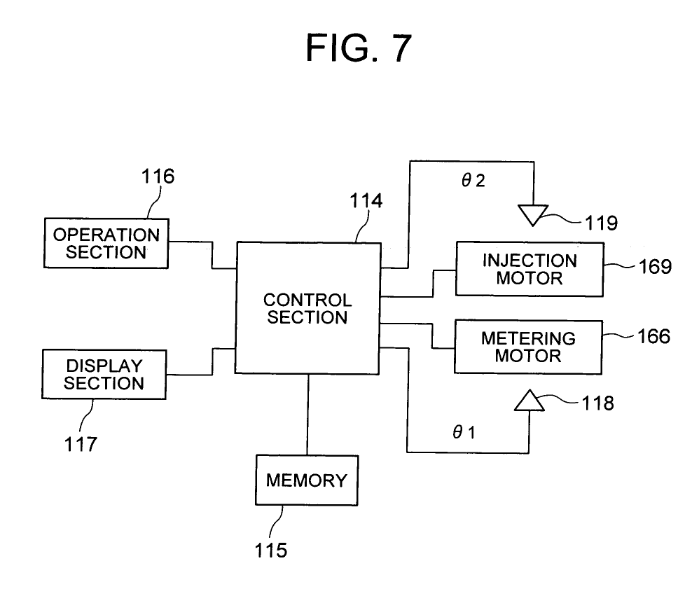

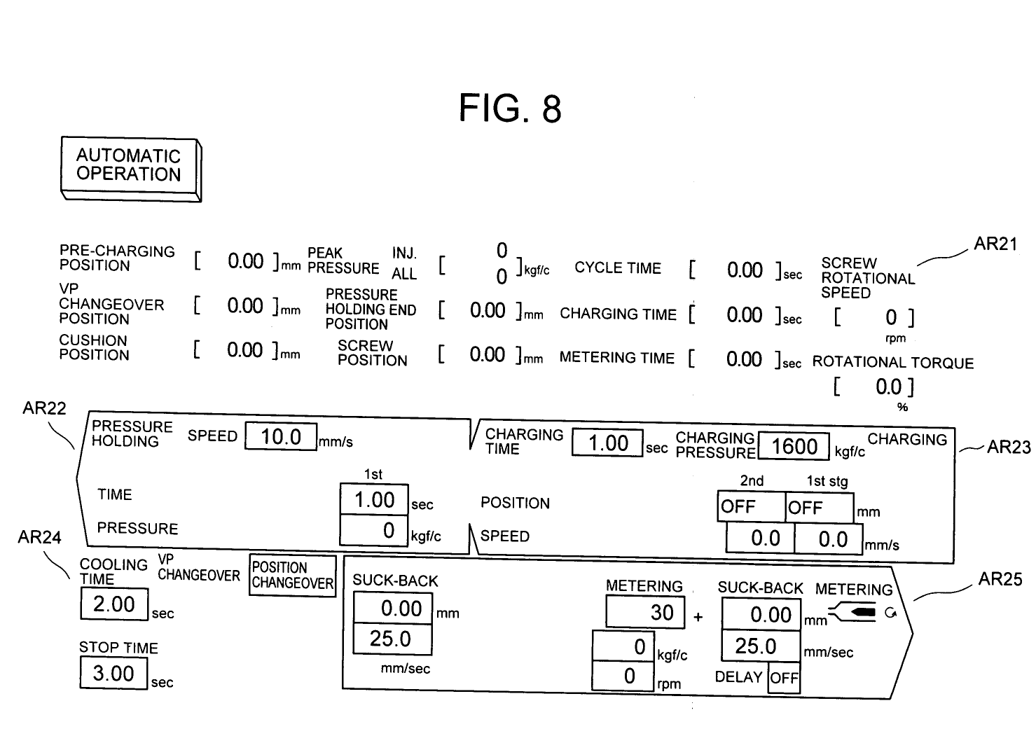

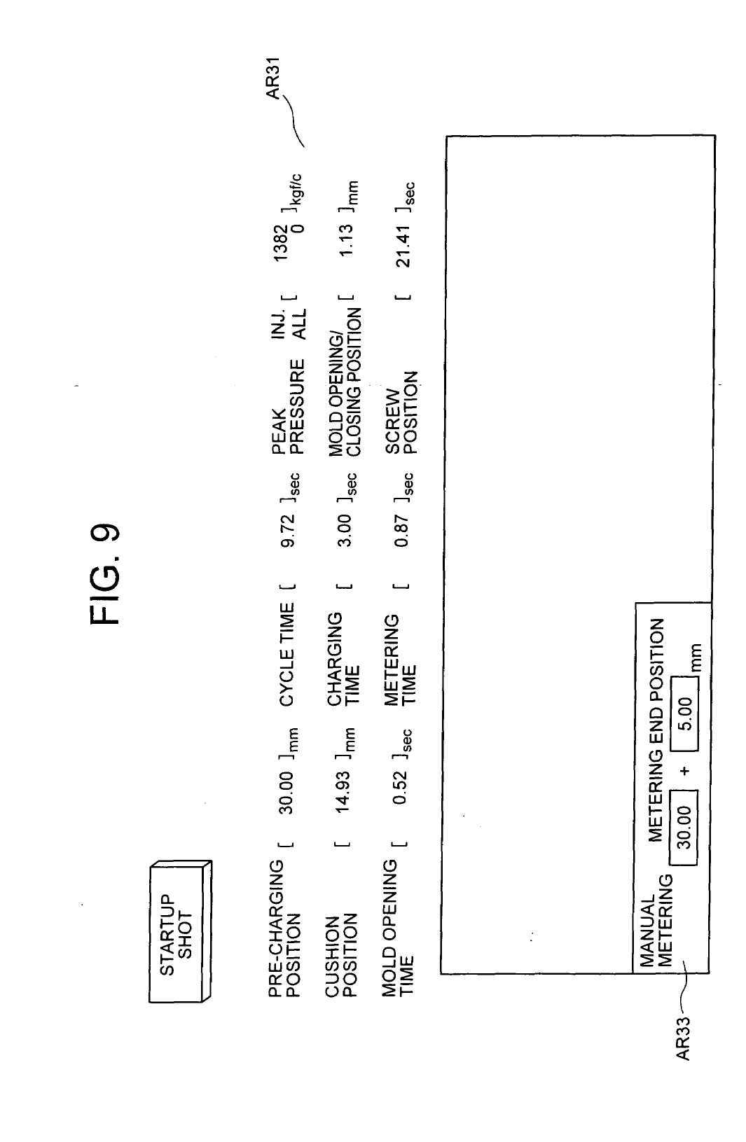

FIG. 7 is a block diagram showing a control circuit of the injection molding machine according to the third embodiment of the present invention. FIG. 8 is a representation showing an example of a first molding-condition input screen in a normal mode in the third embodiment of the present invention. FIG. 9 is a representation showing an example of a second molding-condition input screen in a designated mode in the third embodiment of the present invention.

In FIG. 7, reference numeral 114 denotes a control section. The control section 114 is composed of a CPU (processing apparatus), and functions as a computer on the basis of various data to thereby perform various processing. Notably, in place of the CPU, an MPU may be used as the processing apparatus. Reference numeral 115 denotes memory such as RAM, ROM, flash memory, or the like. Reference numeral 116 denotes an operation section equipped with operating elements such as switches, keys, and buttons. Reference numeral 117 is a display section equipped with a display, lamps, etc. The operation section 116 and the display section 117 are disposed on the above-described operation panel. A touch panel in which the operation section 116 and the display section 117 are integrated together may be used.

Reference numeral 166 denotes the metering motor; and a rotation detection section (encoder, resolver, or the like) 118 which detects the position θ1 of a rotor of the metering motor 166 is disposed on the metering motor 166. Further, reference numeral 169 denotes the injection motor; and a rotation detection section (encoder, resolver, or the like) 119 which detects the position θ2 of a rotor of the injection motor 169 is disposed on the injection motor 169. Unillustrated position-detection processing means (a position-detection processing section) of the control section 114 performs position-detection processing so as to read the position θ1 and detect the position of the screw 157 (FIG. 6) through calculation. Further, unillustrated speed-detection processing means (a speed-detection processing section) of the control section 114 performs speed-detection processing so as to read the position θ1 and differentiate the position θ1 to thereby detect the rotational speed of the metering motor 166, and to read the position θ2 and differentiate the position θ2 to thereby detect the rotational speed of the injection motor 169.

Incidentally, an operator can set molding conditions of the injection molding machine by operating the operation section 116. For such setting, unillustrated display processing means (a display processing section) of the control section 114 performs display processing so as to form, on the display section 117, first and second molding-condition input screens. When the operator inputs predetermined molding conditions on the first and second molding-condition input screens, unillustrated molding-condition-setting processing means (a molding-condition-setting processing section) of the control section 114 performs molding-condition-setting processing so as to set for the injection apparatus 151 molding conditions associated with the metering step as metering conditions and molding conditions associated with the injection step as injection conditions, and set for the mold-clamping apparatus 153 molding conditions associated with mold closing, mold clamping, and mold opening, as mold opening/closing conditions.

The display processing means then forms a molding condition display screen on the display section 117 and displays the set molding conditions on the molding condition display screen.

Subsequently, when an automatic operation of the injection molding machine is started, unillustrated molding processing means (a molding processing section), which serves as second molding-machine-operation processing means (a second molding-machine-operation processing section), of the control section 114 performs molding processing (second molding-machine-operation processing) so as to perform molding under the set molding conditions. That is, first, unillustrated mold-opening/closing processing means (a mold-opening/closing processing section) of the control section 114 performs mold-opening/closing processing so as to drive the mold-clamping motor 196 in accordance with the mold opening/closing conditions, which serve as molding conditions associated with the mold opening/closing operation. Subsequently, unillustrated injection processing means (an injection processing section) of the control section 114 performs injection processing so as to drive the injection motor 169 in accordance with the above-described injection conditions. When charging and pressure holding are completed, unillustrated metering processing means (a metering processing section) of the control section 114 performs metering processing so as to drive the metering motor 166 in accordance with the above-described metering conditions to thereby melt resin. Notably, the above-described injection molding machine is composed of the control section 114, the display section 117, the mold apparatus 152, the mold-clamping apparatus 153, the injection apparatus 151, etc; and the above-described molding machine control apparatus is constituted by the control section 114.

Incidentally, when an automatic operation is performed, the injection molding machine starts the automatic operation from the mold closing operation. At that time, resin for a first shot must be melted in advance, and an operator manually meters the resin; i.e., manual metering is performed, in a metering step for the first shot. Since the manual metering is performed in a state in which no molded disk substrate is present in the cavity and a space forward of the screw 157 within the heating cylinder 156 is not closed, no back pressure is applied to the screw 157. Accordingly, the resin accumulated forward of the screw 157 is not compacted. If resin is injected in this state in the injection step, a sufficient amount of resin cannot be charged into the cavity, so that a molded disk substrate suffers molding failures such as short. As a result, the disk substrate becomes likely to adhere to the inner circumferential surface of the cavity, and take-out of the disk substrate from the mold apparatus 152 becomes difficult.

Further, in a case where the temperatures of the mold apparatus 152 and resin do not become stable and stable molding cannot be performed, similarly, a disk substrate is likely to adhere to the inner circumferential surface of the cavity, and take-out of the disk substrate from the mold apparatus 152 becomes difficult. Examples of such a case include a case where semi-automatic operation is performed so as to determine conditions while taking out a disk substrate after each shot; a case where molding of a predetermined number of shots is performed in a state where molding is unstable (for example, in a case where the injection molding machine is started up); a case where molding is performed while the molding cycle is lengthened (for example, in a case where an anomaly has occurred in a machine in a subsequent stage or the like); a case where molding is performed after the injection molding machine is temporarily stopped due to an error associated with take-out operation of the take-out machine; and a case where molding is performed in a state in which a certain anomaly has occurred in the injection molding machine.

As a result, the operability of the injection molding machine lowers, and/or the productivity of disk substrates lowers.

In order to overcome the above-described problem, in the present embodiment, through operation of the operation section 116, an operator can set the metering conditions differently in accordance with the operation state of the injection molding machine. In the present embodiment, the operator can select one of a normal mode (first operation mode) and a plurality of designated modes (second operation mode). That is, through operation of the operation section 116, the operator can select a desired mode and set metering conditions for each mode. For such operation, buttons for mode selection may be disposed on the operation section 116. Alternatively, a predetermined mode selection screen may be formed on the display section 117, and keys for mode selection may be displayed on the mode selection screen.

Accordingly, the operator can select one of the following modes by operating the operation section 116; i.e., pressing one of the buttons or touching (clicking) one of the keys. When manual metering is performed for the first shot at start of an automatic operation, the operator selects a manual metering mode (first designated mode). When a semi-automatic operation is performed, the operator selects a semi-automatic operation mode (second designated mode). When molding is performed immediately after startup of the injection molding machine, the operator selects a startup mode (third designated mode). When molding is performed with the molding cycle lengthened, the operator selects a molding cycle lengthened mode (fourth designated mode). When molding is performed after the injection molding machine is temporarily stopped, the operator selects a temporary stop mode (fifth designated mode). When molding is performed in a state in which a certain anomaly has occurred in the injection molding machine, the operator selects an anomaly occurrence mode (sixth designated mode).

When the automatic operation is performed after completion of operation in the manual metering mode, the semi-automatic operation mode, the startup mode, the molding cycle lengthened mode, the temporary stop mode, the anomaly occurrence mode, or the like, the operator can select the normal mode.

Further, unillustrated mode-change-condition-determination processing means (a mode-change-condition-determination processing section) of the control section 114 performs mode-change-condition-determination processing so as to determine whether or not a condition for changing the mode; i.e., a mode change condition is satisfied, by determining whether or not the operator has pressed one of the buttons or touched one of the keys through operation of the operation section 116. When the operator presses one of the buttons or touches one of the keys, the mode-change-condition-determination processing means determines that the mode change condition is satisfied, and unillustrated mode-setting processing means (a mode-setting processing section) of the control section 114 performs mode-setting processing so as to determine whether the operator has selected the normal mode or the designated mode, and set the selected mode.

Subsequently, in accordance with the set mode, the display processing means displays the first molding-condition input screen for the normal mode as shown in FIG. 8 or the second molding-condition input screen for the designated mode as shown in FIG. 9.

In FIG. 8, in an area AR21, serving as an actual value display area, there are displayed a pre-charge position representing a position of the screw 157 at the time of start of the injection step; a VP changeover position for changeover between speed and pressure during advancement of the screw 157; a cushion position representing an advance limit position of the screw 157; a peak pressure representing the maximum value of pressure of resin at the time of resin charging; a pressure-holding end position representing a position of the screw 157 at which the pressure-holding ends; a screw position representing position of the screw 157; a cycle time representing the time of the molding cycle; a charging time representing a time during which charging is performed; a metering time representing a time during which metering is performed; a screw rotational speed representing rotational speed of the screw 157; a rotation torque representing torque of the screw 157; etc.

Further, speed of the screw 157, the number of stages of pressure holding, a pressure holding time, and pressure at each time are displayed in an area AR 22, serving as a set value display area. Data associated with charging are displayed in an area AR23. That is, charging time, charging pressure, position of the screw 157, speed of the screw 157 at each position, etc. are displayed in the area AR 23.

Cooling time, stop time, a method for VP changeover, a mode for molding, a method for pressure removal, etc. are displayed in an area AR24.

Further, data associated with metering are displayed in an area AR25. That is, in addition to a suck-back amount, which represents an amount by which the screw 157 is retreated from the position where the metering step is completed, speed of the screw 157 during the suck-back, etc., back-pressure applied to the screw 157 during the metering step, rotational speed of the screw 157, etc. are displayed in the area AR25.

Further, in FIG. 9, in an area AR31, serving as an actual value display area, there are displayed the pre-charge position; the cushion position; a mold opening time representing a time for performing mold opening; the cycle time; the charging time, the metering time, the peak pressure; a mold opening/closing position representing a position at which mold opening/closing is performed; the screw position; etc.

In an area AR33, there are displayed a metering end position; i.e., a position of the screw 157 at which the metering step ends when a disk substrate is manually molded through semi-automatic operation.

When the second molding-condition input screen is displayed as described above, the operator enters various molding conditions of the second molding-condition input screen.

In this case, when the designated mode is set, on the second molding-condition input screen shown in FIG. 9, the operator can change the metering end position, and enters the changed molding conditions as changed conditions. Similarly, along with the metering end position, the operator can change the back-pressure during the metering step, metering rotational speed (rotational speed of the screw 157 during the metering step), the suck-back amount, the cushion position, etc.; and enter the changed molding conditions. Further, the operator can change two or more of the metering end position, the back pressure, the metering rotational speed, the suck-back amount, the cushion position, etc.

Notably, the metering end position is a position of the screw 157 at the time when the metering step ends, and is a variable which defines the amount of resin charged into the cavity. Similarly, the back pressure, the metering rotational speed, the suck-back amount, the cushion position, etc. are variables which define the charge amount.

For example, when the metering end position is shifted backward, the charge amount becomes slightly excessive, and molding can be performed in an over packed state. When the metering end position is shifted forward, the charge amount becomes slightly insufficient, and molding can be performed in a short shot.

As described above, the mode is set on the basis of the state of the injection molding machine, and the molding conditions are changed if necessary. Therefore, stable molding can be performed in any of a state in which disk substrates are molded through automatic operation, a state in which disk substrates are molded through semi-automatic operation, a state in which the injection molding machine is started up, a state in which molding is stable, etc.

Since take-out of disk substrates from the molding apparatus 152 becomes easier, the operability of the injection molding machine can be enhanced, and the productivity of disk substrates can be improved.

Notably, when a molding condition is changed, instead of directly inputting the molding condition, a change amount ±α from the molding condition at the time of automatic operation, which serves as a reference value m, may be entered. In such a case, the display processing means displays the molding condition by use of m and α, for example, m+α and m−α, on the second molding-condition display screen. Further, since the required is mere entry of the change amount ±α, it is possible to prevent occurrence of input errors and erroneous setting. A value in FIG. 9 is related to the metering setting value “30” in FIG. 8. FIG. 9 shows that, in the startup mode, the value is set to be greater than the value in the automatic molding by 5.00 mm.

In the present embodiment, the mode-change-condition-determination processing means determines the state of the injection molding machine by determining whether or not the operator has pressed one of the buttons or touched one of the keys through operation of the operation section 116, to thereby determine whether or not the mode change condition is satisfied. However, the control section 114 can automatically determine the state of the injection molding machine. In such a case, the mode-change-condition-determination processing means receives a signal, such as timing signal, which represents the state of the injection molding machine, and determines the state of the injection molding machine on the basis of the signal. That is, the mode-change-condition-determination processing means determines the state of the injection molding machine; i.e., whether or not the injection molding machine is in a state where manual metering is performed, whether or not the injection molding machine is in a state where semi-automatic operation is performed, whether or not the injection molding machine is in a state where the injection molding machine is started up, whether or not the injection molding machine is in a state where molding is performed with the molding cycle lengthened, whether or not the injection molding machine is in a state where molding is performed after the injection molding machine is temporarily stopped, and whether or not the injection molding machine is in a state where molding is performed after a certain anomaly has occurred in the injection molding machine.

The present invention is not limited to the above-described embodiments. Numerous modifications and variations of the present invention are possible in light of the spirit of the present invention, and they are not excluded from the scope of the present invention.

### INDUSTRIAL APPLICABILITY

The present invention is applicable to take-out machines and injection apparatuses of injection-molding machines.

1. A control apparatus for a molding machine, characterized by comprising:
(a) a state-determination processing section which determines a state of the molding machine;
(b) a mode-setting processing section which sets, on the basis of the determined state of the molding machine, an operation mode in which the molding machine is operated; and
(c) a molding-machine-operation processing section which operates the molding machine in the set operation mode.

2. A control apparatus for a molding machine, characterized by comprising:
(a) a state-determination processing section which determines a state of the molding machine;
(b) a mode-setting, processing section which selects and sets, on the basis of the determined state of the molding machine, one of a normal mode for taking out a molded product by operating a take-out machine with a normal setting and a designated mode for taking out the molded product by operating the take-out machine with a setting different from the normal setting; and
(c) a take-out processing section which takes out the molded product in the set mode.

3. A control apparatus for a molding machine according to claim 2, wherein in the designated mode, a withdrawal return waiting time is set to be longer than that in the normal mode.

4. A control apparatus for a molding machine according to claim 2, wherein in the designated mode, an attraction checking pressure for judging whether a negative pressure supplied to a grasping member is sufficient for attracting the molded product is set to be lower than that in the normal mode.

5. A control apparatus for a molding machine according to claim 2, wherein in the designated mode, a negative pressure supplied to a grasping member is set to be lower than that in the normal mode.

6. A control apparatus for a molding machine according to claim 2, wherein in the designated mode, a stroke over which a grasping member is advanced further after coming into contact with the molded product is set to be longer than that in the normal mode.

7. A control apparatus for a molding machine according to claim 2, wherein in the designated mode, a pressing force with which a grasping member is pressed against the molded product is set to be higher than that in the normal mode.

8. A control method for a molding machine, characterized by comprising:
(a) determining a state of the molding machine;
(b) selecting and setting, on the basis of the determined state of the molding machine, one of a normal mode for taking out a molded product by operating a take-out machine with a normal setting and a designated mode for taking out the molded product by operating the take-out machine with a setting different from the normal setting; and
(c) taking out the molded product in the set mode.

9. A molding machine, characterized by comprising:
(a) a display section; and
(b) a display processing section which forms a first take-out setting input screen for inputting a setting of a take-out machine in a normal mode, and a second take-out setting input screen for inputting a setting of the take-out machine in a designated mode, wherein
(c) the second take-out setting input screen includes an area for changing the setting of the take-out machine in accordance with the state of the molding machine.

10. A control apparatus for a molding machine, characterized by comprising:
(a) a mode-change-condition-determination processing section which determines, on the basis of a state of the molding machine, whether or not a mode changing condition for changing a mode of setting of molding conditions is satisfied;
(b) a mode-setting processing section which determines and sets a selected mode when the mode changing condition is satisfied;
(c) a molding-condition-setting processing section which sets molding conditions in the set mode; and
(d) a molding processing section which performs molding under the set molding conditions.

11. A control apparatus for a molding machine according to claim 10, wherein the mode-change-condition-determination processing section determines whether or not the mode changing condition is satisfied, on the basis of an operation of an operation section by an operator.

12. A control apparatus for a molding machine according to claim 10, wherein the mode-change-condition-determination processing section determines whether or not the mode changing condition is satisfied, by determining the state of the molding machine.

13. A control apparatus for a molding machine according to claim 10, wherein the mode-change-condition-determination processing section determines that the mode changing condition is satisfied when a molding cycle of the molding machine is lengthened.

14. A control apparatus for a molding machine according to claim 10, wherein the molding-condition-setting processing section sets a molding condition which defines a charging amount of a molding material.

15. A control apparatus for a molding machine according to claim 10, wherein the molding condition which defines the charging amount is at least one of metering end position, back pressure, metering rotational speed, suck-back amount, and cushion position.

16. A control method for a molding machine, characterized by comprising:
(a) determining, on the basis of a state of the molding machine, whether or not a mode changing condition for changing a mode of setting of molding conditions is satisfied;
(b) determining and setting a selected mode when the mode changing condition is satisfied;
(c) setting molding conditions in the set mode; and
(d) performing molding under the set molding conditions.

17. A molding machine, characterized by comprising:
(a) a display section; and
(b) a display processing section which forms a first molding-condition input screen for inputting molding conditions in a normal mode, and a second molding-condition input screen for inputting molding conditions in a designated mode, wherein
(c) the second molding-condition input screen includes an area for changing the molding conditions in accordance with the state of the molding machine.
